(19) United States
(12) Patent Application Publication
(10) Pub. No.: US 2026/0087719 A1
(43) Pub. Date: Mar. 26, 2026

(54) IMAGE RENDERING SYSTEM AND METHOD

(71) Applicant: Sony Interactive Entertainment Inc., Tokyo (JP)

(72) Inventor: Alex Dixon, London (GB)

(21) Appl. No.: 19/339,089

(22) Filed: Sep. 24, 2025

(30) Foreign Application Priority Data
Sep. 26, 2024 (GB) 2414149.1

(51) Int. Cl. G06T 15/00; G06T 1/20; G06T 1/60

(52) U.S. Cl. CPC G06T 15/005; G06T 1/20; G06T 1/60; G06T 2210/36

(57) ABSTRACT

A system for rendering images for display, the system comprising a processing unit configured to generate a command buffer comprising one or more indirect draw calls for rendering an image, a level of detail selection unit configured to identify a desired level of detail, LOD, for each asset corresponding to indirect draw calls within the command buffer, a memory management unit configured to select an LOD for use in dependence upon the desired LOD for each asset, and to mark each selected LOD as being in use, and a rendering unit configured to issue one or more draw calls using the selected LODs, and to render an image for display, wherein the memory management unit is configured to mark each selected LOD as not being in use once the image has been rendered.

### CROSS-REFERENCE TO RELATED APPLICATIONS

This application claims the benefit of priority to U.K. Application No. 2414149.1, filed on Sep. 26, 2024, the contents of which are hereby incorporated by reference.

### BACKGROUND OF THE INVENTION

### Field of the Invention

This disclosure relates to an image rendering system and method.

### Description of the Prior Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

When rendering images for display, for instance as a part of a video game, a high latency is typically regarded as being undesirable. This can lead to an increased response time for players of a game, due to increased time between an event occurring and a corresponding image being displayed, for example. Similarly, a higher latency in applications such as virtual reality content can lead to a change of viewpoint in the content lagging behind the user's head motion to an undesirable degree. As such, a reduction in image rendering latency is generally regarded as being desirable.

Latency in the image rendering process has a number of sources, as each step in the rendering process has an associated processing time—this can include the time to perform particular calculations, for example, or the time taken to load assets into memory for use. As such, a number of different approaches to reducing the latency have been considered in earlier arrangements as different approaches seek to mitigate different sources of latency.

It is in the context of the above discussion that the present disclosure arises.

### SUMMARY OF THE INVENTION

This disclosure is defined by claim 1. Further respective aspects and features of the disclosure are defined in the appended claims.

It is to be understood that both the foregoing general description of the invention and the following detailed description are exemplary, but are not restrictive, of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an entertainment system;

FIG. 2 schematically illustrates an image rendering method;

FIG. 3 schematically illustrates a more detailed rendering and LOD management process;

FIG. 4 schematically illustrates an LOD management process;

FIG. 5 schematically illustrates a system for rendering images for display; and

FIG. 6 schematically illustrates a method for rendering images for display.

### DESCRIPTION OF THE EMBODIMENTS

Referring now to the drawings, wherein like reference numerals designate identical or corresponding parts throughout the several views, embodiments of the present disclosure are described.

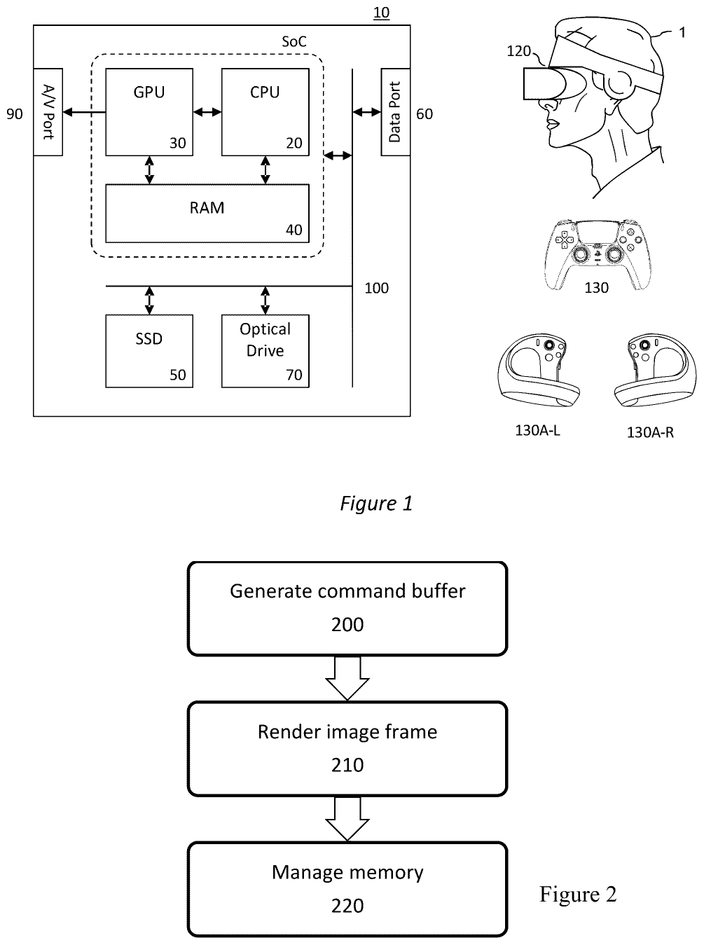

Referring to FIG. 1, an example of an entertainment system 10 is a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC).

Further storage may be provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90 or one or more of the data ports 60.

Where components are not integrated, they may be connected as appropriate either by a dedicated data link or via a bus 100.

An example of a device for displaying images output by the entertainment system is a head mounted display ‘HMD’ 120, worn by a user 1.

Interaction with the system is typically provided using one or more handheld controllers 130, and/or one or more VR controllers (130A-L,R) in the case of the HMD.

Implementations according to the present disclosure seek to mitigate the problem of rendering latency. In particular, this is achieved by modifying the manner in which a GPU is configured to obtain assets having a given level of detail (LOD).

Modern games employ LOD schemes to reduce the memory footprint of geometry and texture data (for example); these enable the GPU to allocate more detail closer to the camera by using a higher LOD, thereby preserving visual quality, and to reduce the memory requirements for distant objects by using a lower LOD. An LOD represents a detail level of an asset with LOD 0 representing the highest detail representation of an asset, and LOD 1 representing a lower detail level which typically has approximately half of the memory footprint of the level above; an example of such a structure is a mipmap.

In large game worlds the total size of the asset data will be too high to be able to fit into the system main memory (RAM) at one time. As a result a system needs to be in place to stream LOD data from a disk (where there is more storage, but access latency is high compared to RAM) and into RAM for the assets that are currently visible on screen. In order to maximise the use of the RAM's available storage this typically comprises allocating more memory to assets that are close to the camera or have a high screen coverage, and allocating less memory to assets which cover a small area of screen coverage. To manage this process, in existing arrangements the CPU typically controls a memory allocation process and a read-from-disk process as a part of the rendering of an image; this control is typically performed in response to an object visibility culling process and LOD selection.

The CPU is also used to build a command buffer that is transmitted to the GPU, with the GPU executing this command buffer to perform the rendering process. This command buffer includes draw calls for assets at a desired LOD for objects that are expected to be visible in the frame being rendered. Once a first buffer has been sent to the GPU, the next buffer is built while the first is being executed by the GPU—this is referred to as double buffering, and this can be extended to triple buffering in which a third buffer is prepared while the first is being executed. While this is generally considered to be advantageous, for instance due to leading to a reduction in frame tears, this can cause the memory allocation and read processing to become more complex. This is because each of the command buffers may reference different assets and/or LODs of assets, which can lead to the risk of deallocating memory before the corresponding asset has been utilised.

In order to address this risk, the CPU and GPU perform a synchronisation on a regular basis—this synchronisation enables the CPU to be updated on the processing which has been performed by the GPU, which can therefore lead to an identification of assets which have already been utilised (and corresponding memory can therefore be deallocated). Such a synchronisation is typically performed when a new command buffer is submitted to the GPU for execution; while this introduces a significant latency to the memory management, this is considered essential to ensure that assets are not deallocating during (or prior to) use by the GPU.

It is therefore considered that an improved method of memory management is desirable, so as to provide the same advantages in a more efficient and lower-latency manner.

Implementations in accordance with the present disclosure seek to fulfil this purpose by enabling the GPU to drive the LOD synchronisation, rather than the CPU as is traditionally the case. In particular, such implementations enable LOD requests to be made from the GPU directly, thereby reducing the associated latency. In order to support this, an alternative approach to memory management is also proposed.

FIG. 2 schematically illustrates an image rendering method in accordance with the present disclosure. While the steps below are described in a sequential manner, it would be appreciated that the steps and independent and as such may be performed in a substantially overlapping manner (such as generating a second command buffer while the first is being executed). It is also considered that the steps may be performed in a repeated or continuous manner, such that a plurality of frames are rendered by performing the steps multiple times. It is also considered that the step 220 need not be performed as frequently as the other steps—such as performing a memory management process every other frame, or on any other basis (such as elapsed time)—as an example of asynchronous implementation.

A step 200 comprises generating a command buffer at the CPU, the command buffer being used to instruct the rendering of an image frame. Rather than specifying a particular LOD in the draw calls that are present in the command buffer, the draw calls may be indirect draw calls which instruct rendering but leave it to the GPU to determine an appropriate LOD for use. The command buffer is then transferred to the GPU for execution. By deferring the selection of the LOD that is to be used, there is more time to load a desired LOD into memory before committing to using a particular LOD—this can therefore reduce latency, as the time spent waiting for a particular LOD to be loaded into memory for use can be reduced.

A step 210 comprises rendering the image frame at the GPU based upon the instructions in the command buffer. This rendering may comprise any suitable processes for generating an image for display. A first step may include culling objects based on visibility (such as frustum culling or occlusion culling), while a second step includes selecting a desired LOD for each of a plurality of draw calls. A third step comprises performing the rendering of the scene view using rasterization or raytracing processes.

A step 220 comprises the performing of a memory management process for LODs. This can be performed by the CPU or using Async-compute pipes on the GPU. This step comprises obtaining assets at a given LOD in accordance with requests made by the GPU in the rendering process, as well as allocating these to memory. Once the assets have been used, such that a particular LOD is no longer required, the memory can be deallocated in a process described in more detail below.

Implementations in accordance with the present disclosure utilise a unified memory structure as a part of the LOD management. This structure can be used alongside atomic operations (that is, an operation which comprises a sequence of instructions that are run without interruption) to ensure that a reliable operation of the LOD management is realised.

This unified memory structure comprises three different data fields-one indicating a desired LOD for an asset, one indicating the availability of each LOD for an asset, and one indicating the time of last use of each LOD for an asset. In the latter two instances, the data fields comprise a number of entries determined in dependence upon the number of LODs available. The unified memory structure may comprise an array with entries for each asset which is available to the content being rendered (such as each asset associated with a video game), although any suitable format may be utilised.

The desired LOD (desired_lod) is represented as an integer on a per asset basis. It is written during the rendering task, in response to the selection of a desired LOD by the GPU as a part of the rendering of a scene view. The integer value of the desired LOD is written to the unified data structure, with 0 representing the most detailed LOD, 1 the next-most detailed, and so on up to n where n is the number of LOD levels within the asset. A value may also be set which indicates that no LOD is desired for that asset, in the case that the corresponding asset is not a part of the scene being rendered—this may be implemented in any suitable manner, such as using a 0 to represent no desired LOD with the variable instead being desired_lod+1. Alternatively, a value of n may be used as the overheads associated with loading the n^{th} LOD are typically sufficiently small so as to be considered negligible—in some implementations, the n^{th} LOD for each asset (or at least a preferred low-detail representation of those assets) are loaded into memory as a fall-back in case the asset is needed for rendering.

The availability of each LOD is indicated by available_in_use_lod data entries, which can be represented as an integer mask, and each asset will contain an array of these (one per LOD level in the asset). These data entries are used to indicate whether the corresponding LOD is available and/or in use. Here, available means that the LOD has been allocated in memory and is able to be safely used for rendering (in that the LOD is not already in use); in use means that the asset has been locked due to being used by the GPU for rendering (and therefore should not be deallocated from memory).

Any suitable manner of expressing this information can be utilised; one example is a binary representation as follows:

| | |
|---|---|
| available_in_use_lod0 = 0b01 | (LOD 0 is available, and is not in use) |
| available_in_use_lod2 = 0b00 | (LOD 2 is not available, and is not in |
| | use) |
| available_in_use_lod5 = 0b11 | (LOD 5 is available, and is in use) |

In this representation, the final bit represents the availability while the penultimate bit represents whether the LOD is in use. Accordingly, 0b10 is an invalid value because an LOD cannot be in use if it is not available.

The time of last use (last_used_lod) can be represented as an integer timestamp for each LOD associated with an asset. This can be in the form of a Unix timestamp, for example, or may use a more tailored reference to reduce the number of bits required to store a timestamp-such as measuring the number of elapsed seconds since release of the content.

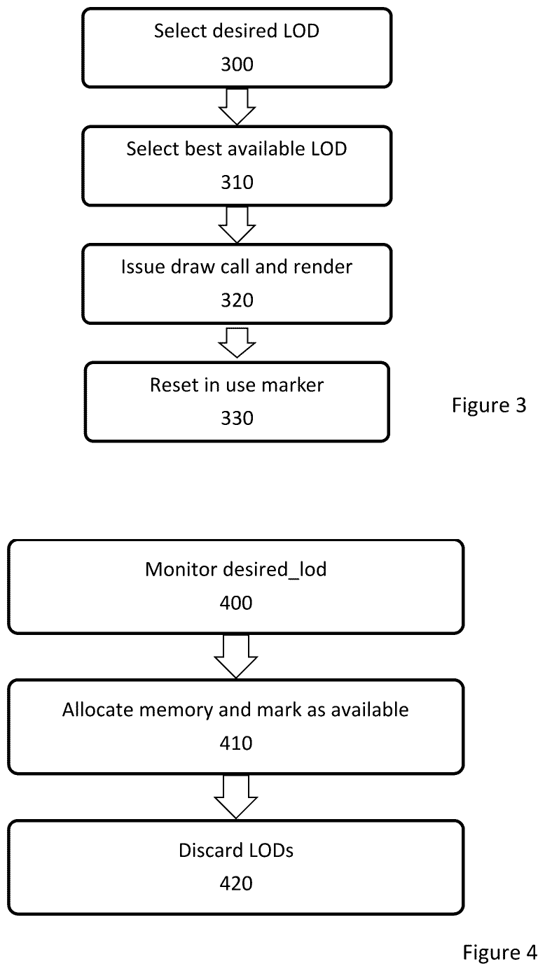

FIG. 3 schematically illustrates a more detailed rendering and LOD management process, with this process being an example of an implementation in accordance with the more general method described with reference to FIG. 2. This process is performed for each asset that corresponds to the scene being rendered, such as each asset for which an indirect draw call exists within the command buffer being executed by the GPU.

A step 300 comprises selecting the desired LOD for visible assets in a scene, and updating the corresponding asset's desired_lod data accordingly. The selection of the desired LOD can be performed in any suitable manner; typically this is performed using a process executed at the GPU which selects an appropriate LOD in dependence upon factors such as the screen space occupied by an asset, or how near to the rendering viewpoint the asset is. Of course, any other factors may also be considered-such as an assigned significance value for an asset (indicating its importance within a rendered scene), or any other indicator of a preferred LOD. If an asset is culled due to not being visible within the scene, then the LOD is set to the maximum value (that is, the lowest level of detail) or an alternative predetermined value.

A step 310 comprises selecting the best available LOD that is not in use, and marking this LOD as being in use. This is achieved by identifying which LODs are available for a given asset using the unified memory structure, selecting one of these (the desired LOD, or if that is not available then either the highest available LOD that does not exceed the desired LOD or the nearest LOD to the desired LOD may be selected). Here, ‘best available’ can be interpreted to mean the LOD that best approximates the desired LOD within any given constraints-such constraints may be used to manage the memory demands of the rendering process (such as requiring that the selected LOD is not a higher quality than the desired LOD where possible), for example, or to ensure a given level of quality (such as requiring that the selected LOD is not a lower quality than the desired LOD where possible).

As noted above, a low-quality LOD is typically available for each asset at all times so as to ensure that there is an available LOD to be selected (even if the LOD would be of an undesirable quality). This can ensure that the process is a robust one, as if no LOD is available then this can cause the rendering process to encounter an error.

The entry associated with that LOD in the unified memory structure is then modified to indicate that it is in use. This selection and marking of the LOD is preferably performed in a single atomic operation, for instance using an Interlocked Compare Exchange function; by using a single function, the efficiency of the process can be improved. This step is typically performed on a per-draw-call basis. At this stage, a time stamp can also be updated for that LOD within the unified memory structure so as to indicate the use of that LOD.

Once selected, the best available LOD is used to update the corresponding indirect draw call so as to indicate a specific LOD to be used.

An exemplary implementation may be provided in accordance with the below pseudo-code representation of this step.

```
// for each draw call
int lod = lod_count;
for(int i = desired_lod; i < lod_count; ++i)
{
  int value = 0;
  InterlockedCompareExchange(available_in_use_lod[i], 0b01,
  available_in_use_lod[i], value);
  if(value == 0b11)
  {
// we can use lod level i
lod = i;
// set the timestamp
      last_used_lod[i] = timestamp;
break;
  }
  else
  {
    // iterate to the next detailed lod and see if it is available
  }
}
if(lod == lod_count)
{
  // this means the draw call is not visible and can be discarded
  Return; // return early
}
// populate indirect draw arguments
```

A step 320 comprises issuing a draw call on the basis of the selected LOD, and performing the rendering operations using the selected LOD. As the LOD has been marked as in use, it is not at risk of being used by other processes being executed at the GPU.

A step 330 comprises resetting the ‘in use’ mask associated with the selected LOD once the rendering operations using that LOD have been completed; a reset here means setting the ‘in use’ mask to indicate that the selected LOD is no longer in use. This may be implemented using a compute shader task that is executed after the rendering point, which can (for instance) utilise an InterlockedAnd atomic operation. The timing of this step can be managed using any suitable synchronisation process for a given arrangement; the aim is to ensure that the reset is performed at a time at which it can be ensured that the previously-selected LODs are no longer in use. At this stage, there is no change to the availability of the LOD—only the ‘in use’ mask is changed.

The method of FIG. 3 therefore demonstrates a process of selecting an LOD, locking it from use by other processes, and using that LOD for rendering. Once the rendering is completed, the LOD is unlocked so that it can be used by other processes where desired.

In some implementations, modifications may be made to the rendering process in order to maximise the benefits that are able to be obtained. For instance, the order in which tasks are performed by the GPU may be modified so as to frontload tasks that don't require texture detail (such as generating shadow maps). By performing these tasks first, the amount of time between determining a desired LOD and using it can be increased without introducing an additional latency to the rendering process.

FIG. 4 schematically illustrates an LOD management process which can be executed alongside the rendering process and the LOD management of FIG. 3; while the process of FIG. 3 deals with managing the use of LODs so as to manage the ‘in use’ aspect, the process of FIG. 4 deals with the obtaining and discarding of LODs so as to manage the ‘available’ aspect. While shown here as being separate steps in a particular order, these may be performed in any order and on a continuous basis. In some cases, the steps may be performed at the same time (or at least overlap to some degree)

A step 400 comprises monitoring the desired_lod data field for each asset, and comparing it to the corresponding available_in_use data field for the desired LOD. If there is a mismatch between these values (that is, if the desired LOD is not available), then the desired LOD is added to a list of assets to be obtained.

This can be implemented in a number of different ways; for instance, it may be undesirable to obtain certain assets at a desired LOD due to memory constraints, or the order in which the LODs are obtained may be significant (for instance, based upon asset importance or prominence, or a rendering order). In line with this, a prioritisation or selection algorithm can be used to determine which LODs should be obtained and in which order. In some cases, should it be considered impractical (or otherwise undesirable) to obtain the desired LOD this process may identify an appropriate alternative-such as obtaining the next most detailed LOD. Any suitable selection or prioritisation process may be utilised, in accordance with the details of a particular implementation.

A step 410 comprises allocating memory for an LOD, reading the corresponding LOD into memory, and marking that LOD as being available for use by the rendering process. This may use an InterlockedOr operation to mark the LOD as being available.

A step 420 comprises discarding one or more LODs that are not in use. The LODs that are discarded (that is, deallocating the memory corresponding to the LOD) can be selected in any suitable manner—typically these are considered to be low priority LODs, or LODs that meet some criteria regarding size or frequency of use. For instance, LODs may be discarded once they exceed a certain amount of time (or number of rendered image frames) since they were last used (based on the last_used_lod data), or LODs having a small size may be prioritised (as these can be readily obtained again as required) or a large size (so as to free up more memory for other assets).

Once discarded, the available flag should be updated to reflect the fact that the LOD is no longer available—this can be achieved using an InterlockedCompareExchange operation, for example.

Implementation of a method in accordance with FIG. 4 therefore enables LODs to be loaded into memory, used for rendering, and then discarded from memory in a robust and efficient manner.

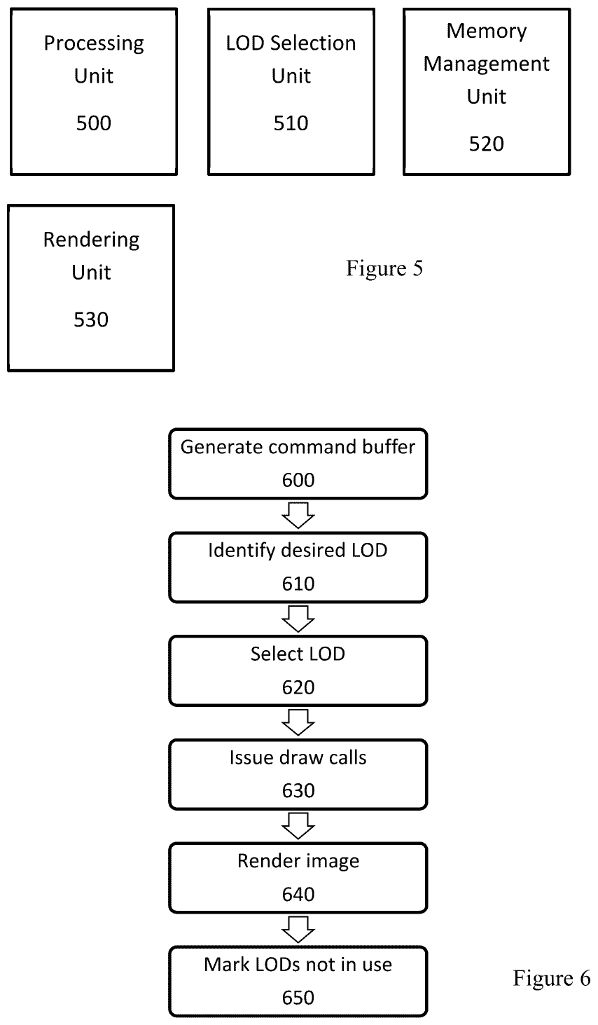

FIG. 5 schematically illustrates a system for rendering images for display, the system comprising a processing unit 500, an LOD selection unit 510, a memory management unit 520, and a rendering unit 530. In some implementations, the processing unit 500 is embodied in a CPU and the LOD selection unit 510, memory management unit 520, and rendering unit 530 are embodied in a GPU. However, in some cases the operations of at least the memory management unit 520 (for example) may be realised by a combination of CPU and GPU hardware as appropriate. The processing described in respect of each of these units can be performed in accordance with the discussion above with reference to FIGS. 2, 3, and 4 as appropriate.

The processing unit 500 is configured to generate a command buffer comprising one or more indirect draw calls for rendering an image. These draw calls correspond to assets within an image frame to be rendered, and are considered to be indirect in that they indicate an asset but not a specific LOD to be used for that asset.

The level of detail selection unit 510 is configured to identify a desired level of detail, LOD, for each asset corresponding to indirect draw calls within the command buffer. The desired LOD can be determined for each asset in dependence upon the screen space occupied by an asset and/or a distance of the asset from the viewpoint from which the image is rendered, for example.

In some implementations, the level of detail selection unit 510 is configured to identify the desired LOD for each asset after a culling process has been performed (for instance, by the rendering unit 530). The level of detail selection unit 510 is configured to select a predetermined LOD as the desired LOD for each culled asset—this may be the lowest-quality LOD for that asset, for example, or any other determination of an available asset to utilise instead so as to reduce the LOD obtaining burden.

The memory management unit 520 configured to select an LOD for use in dependence upon the desired LOD for each asset, and to mark each selected LOD as being in use. In some instances, the memory management unit 520 is configured to select the desired LOD as the LOD for use. However, this LOD may not always be available; in such a case the memory management unit 520 may be configured to select the highest-quality available LOD that has a quality lower than the desired LOD for use or any other available LOD (such as a highest-quality LOD, or nearest LOD).

Rather than defaulting to using an LOD other than the desired LOD, the memory management unit 520 can be configured to obtain the desired LOD from storage and to load it into memory for use by the rendering unit. A method for this is discussed above with reference to FIG. 4.

The memory management unit 520 may be configured to maintain a data structure which indicates, for each asset, the desired LOD, the availability and in-use status of each LOD, and the time of last use of each LOD. This may be the unified memory structure described above. However, it is also considered that any other suitable method of storing this information may be utilised—such as per-asset repositories of information, or groups of assets corresponding to a particular game level or other subset of content being rendered. In any case, the memory management unit 520 may be configured to maintain the data structure using atomic operations—while not essential, this is considered preferable as it reduces the likelihood of encountering errors in the rendering process.

The memory management unit 520 can also be configured to deallocate LODs from memory in response to an above-threshold amount of time having elapsed since the LOD was last used, or any other alternative or additional criteria. Such a process is described above with reference to FIG. 4. This process can mitigate the problem of memory becoming full with LODs that are not in demand; rather than storing them indefinitely, they can be re-obtained at a later time.

The rendering unit 530 is configured to issue one or more draw calls using the selected LODs, and to render an image for display. Once the image has been rendered, the memory management unit 520 is configured to mark each selected LOD as not being in use. This image can be output to a display device, such as a television, for immediate display; alternatively, rendered images can be stored for a later playback.

The arrangement of FIG. 5 is an example of a processor (for example, a GPU and CPU located in a games console or any other computing device) that is operable to render images for display, and in particular is operable to:
generate a command buffer comprising one or more indirect draw calls for rendering an image;
identify a desired level of detail, LOD, for each asset corresponding to indirect draw calls within the command buffer;
select an LOD for use in dependence upon the desired LOD for each asset, and to mark each selected LOD as being in use;
issue one or more draw calls using the selected LODs;
render an image for display; and
mark each selected LOD as not being in use once the image has been rendered.

Turning to FIG. 6, this schematically illustrates a method for rendering images for display. This method may be implemented in accordance with the discussion of the system of FIG. 5, for instance, and any other features disclosed in the present document.

A step 600 comprises generating a command buffer comprising one or more indirect draw calls for rendering an image.

A step 610 comprises identifying a desired level of detail, LOD, for each asset corresponding to indirect draw calls within the command buffer.

A step 620 comprises selecting an LOD for use in dependence upon the desired LOD for each asset, and marking each selected LOD as being in use.

A step 630 comprises issuing one or more draw calls using the selected LODs.

A step 640 comprises rendering an image for display.

A step 650 comprises marking each selected LOD as not being in use once the image has been rendered.

It is noted that steps 610, 620, 630, and 650 (and correspondingly, the respective processing by the LOD selection unit 510 and the memory management unit 520 of FIG. 5) may be implemented multiple times within a frame, rather than being limited to being performed once per rendered frame. This may be advantageous in that it enables a more responsive memory management process, which in turn can increase the quantity of memory management that can be performed. This can also enable other processes which are dependent upon these steps (or the results of these steps) to be performed in a more responsive (lower latency) fashion.

For instance, by performing these steps in a more dynamic fashion the amount of time for a process such as the one described with reference to FIG. 4 to be implemented is increased as information about desired and in-use LODs is updated more frequently. In other words, this can reduce delays such as the delay between an asset having been used and being marked as such (that is, having the available_in_use flag reset as appropriate).

The techniques described above may be implemented in hardware, software or combinations of the two. In the case that a software-controlled data processing apparatus is employed to implement one or more features of the embodiments, it will be appreciated that such software, and a storage or transmission medium such as a non-transitory machine-readable storage medium by which such software is provided, are also considered as embodiments of the disclosure.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A system for rendering images for display, the system comprising:
a processing unit configured to generate a command buffer comprising one or more indirect draw calls for rendering an image;
a level of detail selection unit configured to identify a desired level of detail, LOD, for each asset corresponding to indirect draw calls within the command buffer;
a memory management unit configured to select an LOD for use in dependence upon the desired LOD for each asset, and to mark each selected LOD as being in use; and
a rendering unit configured to issue one or more draw calls using the selected LODs, and to render an image for display,
wherein the memory management unit is configured to mark each selected LOD as not being in use once the image has been rendered.

2. The system of claim 1, wherein the level of detail selection unit is configured to identify the desired LOD for each asset in dependence upon the screen space occupied by an asset and/or a distance of the asset from the viewpoint from which the image is rendered.

3. The system of claim 1, wherein:
the level of detail selection unit is configured to identify the desired LOD for each asset after a culling process has been performed, and
the level of detail selection unit is configured to select a predetermined LOD as the desired LOD for each culled asset.

4. The system of claim 3, wherein the predetermined LOD is the lowest-quality LOD.

5. The system of claim 1, wherein the memory management unit is configured to select the desired LOD as the LOD for use.

6. The system of claim 1, wherein the memory management unit is configured, when the desired LOD is not available, to select the highest-quality available LOD that has a quality lower than the desired LOD for use.

7. The system of claim 1, wherein the memory management unit is configured to obtain the desired LOD from storage and to load it into memory for use by the rendering unit.

8. The system of claim 1, wherein the memory management unit is configured to maintain a data structure which indicates, for each asset, the desired LOD, the availability and in-use status of each LOD, and the time of last use of each LOD.

9. The system of claim 8, wherein the memory management unit is configured to maintain the data structure using atomic operations.

10. The system of claim 1, wherein the memory management unit is configured to deallocate LODs from memory in response to an above-threshold amount of time having elapsed since the LOD was last used.

11. The system of claim 1, wherein the processing unit is embodied in a CPU and the LOD selection unit, memory management unit, and rendering unit are embodied in a GPU.

12. A method for rendering images for display, the method comprising:
generating a command buffer comprising one or more indirect draw calls for rendering an image;
identifying a desired level of detail, LOD, for each asset corresponding to indirect draw calls within the command buffer;
selecting an LOD for use in dependence upon the desired LOD for each asset, and marking each selected LOD as being in use;
issuing one or more draw calls using the selected LODs;
rendering an image for display; and
marking each selected LOD as not being in use once the image has been rendered.

13. The method of claim 12, further comprising:
identifying the desired LOD for each asset in dependence upon the screen space occupied by an asset and/or a distance of the asset from the viewpoint from which the image is rendered.

14. The method of claim 12, further comprising:
identifying the desired LOD for each asset after a culling process has been performed, and
selecting a predetermined LOD as the desired LOD for each culled asset.

15. The method of claim 14, wherein the predetermined LOD is the lowest-quality LOD.

16. The method of claim 12, further comprising:
selecting the highest-quality available LOD that has a quality lower than the desired LOD for use.

17. A non-transitory computer-readable storage medium w having stored therein a program for causing a computer to execute a process for rendering images for display, the process comprising:
generating a command buffer comprising one or more indirect draw calls for rendering an image;
identifying a desired level of detail, LOD, for each asset corresponding to indirect draw calls within the command buffer;
selecting an LOD for use in dependence upon the desired LOD for each asset, and marking each selected LOD as being in use;
issuing one or more draw calls using the selected LODs;
rendering an image for display; and
marking each selected LOD as not being in use once the image has been rendered.

18. The non-transitory computer-readable medium of claim 17, wherein the process further comprises:
identifying the desired LOD for each asset in dependence upon the screen space occupied by an asset and/or a distance of the asset from the viewpoint from which the image is rendered.

19. The non-transitory computer-readable medium of claim 17, wherein the process further comprises:
identifying the desired LOD for each asset after a culling process has been performed, and
selecting a predetermined LOD as the desired LOD for each culled asset.

20. The non-transitory computer-readable medium of claim 19, wherein the predetermined LOD is the lowest-quality LOD.
